(19) United States
(12) Patent Application Publication
(10) Pub. No.: US 2026/0043508 A1
(43) Pub. Date: Feb. 12, 2026

(54) Flexible pipe and method of connecting an end fitting to a pipe body of a flexible pipe

(71) Applicant: Polyflow LLC, Midland, TX (US)

(72) Inventors: Zhimin TAN, Katy, TX (US); Liang Yu, Katy, TX (US); Timothy Lee CURETON, Arvada, CO (US); Linfa ZHU, Houston, TX (US); Jeffrey K. SHORTER, Magnolia, TX (US)

(73) Assignee: Polyflow LLC, Midland, TX (US)

(21) Appl. No.: 18/797,934

(22) Filed: Aug. 8, 2024

(51) Int. Cl. F16L 47/02; F16L 11/14

(52) U.S. Cl. CPC F16L 47/02; F16L 11/14

(57) ABSTRACT

A flexible pipe comprising a pipe body, an end fitting, and a retaining material. The pipe body has a first pipe layer formed of a tape comprising a plurality of metallic wires encapsulated in a thermoplastic matrix material. The first pipe layer is at least partially free of the matrix material over a length of the pipe body at a first end thereof so exposing a portion of the metallic wires. The first end of the pipe body is mounted in the end fitting. The end fitting comprises a mounting member concentric to the first pipe layer. The retaining material is applied to the exposed portion of the metallic wires securing the metallic wires to the mounting member. There is also provided a method of connecting an end fitting to a pipe body of a flexible pipe.

### TECHNICAL FIELD

The invention relates to a flexible pipe, particularly to a flexible pipe for conveying oil and gas field fluids. The invention further relates to the use of such a pipe, and to a method for connecting an end fitting to a pipe body of such a pipe.

### BACKGROUND

Flexible composite pipe has been replacing steel in many applications with great success, including oil and gas pipelines, due to its versatility and durability. Flexible composite pipe is used in conveying oil and gas field fluids, such as water, gas (for example methane, ethane, CO₂) and hydrocarbon fluids, or other fluids such as hydrogen, and is typically used onshore or in shallow water applications (for example, less than 500 m water depth).

Reinforced thermoplastic pipe (RTP) is an example of a multi-layer flexible composite pipe reinforced by high-strength materials. RTP is suited to gas and oil transportation because of its ultra-low permeability and high strength, being capable of internal pressures exceeding 5,000 psi (^{˜}34.5 MPa), and may be qualified and supplied in accordance with the American Petroleum Institute specification API 15S. RTP is corrosion-resistant and more durable than steel pipe: RTP can withstand salt corrosion, as well as H₂S/CO₂ corrosion, hence contributing to a longer lifespan when compared to steel pipe. Moreover, RTP can provide high flowrates due to a smooth inner surface and the inherent flexibility of the pipe, which removes the need for elbows.

RTP typically comprises at least one reinforcement layer to withstand internal pressure and/or tension in the pipe when in use. Such reinforcement layer may comprise long fibres, fibre strands, braids and the like, the filaments of which may be from one or more of steel, glass, carbon, aramid, basalt, or polyester, and which may also comprise a matrix material of a thermoplastic polymer. Fibres and/or strands or braids of fibres may be wound around the pipe in a helical manner, with lay angles optimised for pipe performance (the higher the angle the greater the pressure retainment capability, the lower the angle the greater the tension capability), or interwoven into a braid around the liner pipe. Multiple layers of reinforcement may be applied sequentially at different lay angles to optimise and provide torsional balance to the structure in manufacture and use, i.e., RTP may comprise one or more intermediate reinforcement layers.

RTP may further comprise an inner liner of polymer, and an outer protective polymeric sheath layer. The inner liner layer may comprise a single layer and material, or a plurality of sub-layers co-extruded or co-axially extruded over each other with optional tie layers to ensure retaining between incompatible polymer layers. Polymers for RTP manufacture include MDPE, HDPE, XLPE, PE-RT, polyamides (for example PA-12, PA-11, PA-66, PA-6), thermoplastic elastomers, flexible polyvinyl chloride, acrylonitrile butadiene styrene (ABS), polyphenylene sulphide (PPS), though other polymers or polymer alloys may be used. RTP may comprise filled polymers where the polymer contains a portion of a filler material, such as fibres or particles.

RTP may be either of an unbonded construction, where the layers of the pipe are unbonded to each other, i.e., the inner fluid containing polymer liner layer is not bonded to the reinforcement layer, which is in turn not bonded to the outer protective sheath polymer layer, or of a bonded construction, i.e., all layers are bonded to each other as part of the pipe manufacturing resulting in a pipe which is in effect a single, consolidated layer comprising sub-layers. Unbonded RTP may be suitable for similar applications to bonded RTP, but is manufactured differently. In comparison with bonded RTP, unbonded RTP may be manufactured more quickly (as there is no need to bond or consolidate layers along the full length of the pipe, nor additional inspection to confirm such retaining is achieved), and is therefore more cost effective, and results in a pipe which is more flexible during handling and installation, being able to maintain and operate at a smaller bend radius without risk of damage to the pipe structure.

An end fitting, or coupling, provides a sealing transition between the pipe and a connecting component, and transmits normal service loads acting on the pipe without allowing the pipe to fail. End fittings may be used for connecting sections of RTP to one another or for connecting a section of RTP to, for example, terminal equipment. As such, RTP can be used, inter alia, to provide a flexible composite pipe assembly for transporting fluids from a well-head location to an export terminus, or to a refinery. In such a pipe assembly, a first section of RTP may be connected to one or more further sections of RTP. Each section of RTP may include at least one end fitting.

With higher pressure applications, the end fitting may need to be relatively longer in order provide efficient load transfer between the reinforcement layer(s) of the pipe and the end fitting without slipping or failure at the joint. Problematically, longer end fittings increase the weight of the fitting and increase the minimum bend radius, both of which reduce the ease of handling and installation. This is particularly problematic were the connection the end fitting to the pipe body is performed on site, which is common for RTP.

It is an object of embodiments of the invention to reduce the length of end fittings, in particular for RTP, and/or at least mitigate one or more problems associated with known arrangements.

### SUMMARY OF THE INVENTION

According to an aspect of the invention, there is provided a flexible pipe comprising: a pipe body having a first pipe layer comprising a plurality of metallic wires, e.g., reinforcing wires, encapsulated in a matrix material, the first pipe layer at least partially free of the matrix material over a length of the pipe body at a first end thereof so exposing a portion of the metallic wires; an end fitting in which the first end of the pipe body is mounted, the end fitting comprising a mounting member concentric to the first pipe layer, i.e., disposed concentrically relative to the first pipe layer; and a retaining material applied to the exposed portion of the metallic wires securing the metallic wires to the mounting member.

This arrangement may improve load transfer between the metallic wires of the first pipe layer and the end fitting, and therefore allow for shorter end fittings. Shorter end fittings reduce material use, thereby reducing weight, and allow for smaller bend radii at the ends of the pipe, both of which improve ease of handling and installation.

In certain embodiments, the first pipe layer may be formed of a tape which comprises the plurality of metallic wires, and/or the matrix material may be a thermoplastic matrix material.

In certain embodiments, the retaining material may be an adhesive or may be adhesively bonded to the mounting member.

In certain embodiments, the retaining material may be an epoxy resin or other adhesive polymer material, and optionally the retaining material may comprise a filler material for increasing stiffness.

In certain embodiments, the end fitting may comprise a port for introducing the retaining material between the first pipe layer and the mounting member, and optionally the port may include a valve.

In certain embodiments, the retaining material may provide that the first end of the pipe body is an enlarged end.

In certain embodiments, the pipe body may further have a second pipe layer disposed about the first pipe layer, the second pipe layer not extending over the length of the pipe body at the first end.

In certain embodiments, the mounting member may comprise a ferrule disposed about the second pipe layer.

In certain embodiments, the second pipe layer may be a polymer layer and/or may provide a fluid barrier layer of the pipe body.

In certain embodiments, the pipe body may further have a third pipe layer about which the first pipe layer is disposed, the third pipe layer not extending over the length of the pipe body at the first end.

In certain embodiments, the mounting member may comprise a stem disposed within the third pipe layer.

In certain embodiments, the third pipe layer may be a polymer layer and/or may provide a liner of the pipe body.

In certain embodiments, the end fitting may comprise an annular channel that is concentric to the length of the pipe body at the first end thereof.

According to another aspect of the invention, there is provided the use of a flexible pipe according to the invention as an onshore pipe for conveying oil and gas field fluids, and wherein optionally the flexible pipe is a reinforced thermoplastic pipe.

According to yet another aspect of the invention, there is provided a method for connecting an end fitting to a pipe body of a flexible pipe, the method comprising: providing a pipe body having a first pipe layer formed of a tape comprising a plurality of metallic wires (e.g., reinforcing wires) encapsulated in a thermoplastic matrix material; removing at least a portion of the matrix material from the first pipe layer over a length of the pipe body at a first end thereof to expose a portion of the metallic wires; providing an end fitting having a mounting member and introducing the first end of the pipe body into the end fitting such that the mounting member is concentric to the first pipe layer (i.e., disposed concentrically relative to the first pipe layer); and applying a retaining material to the exposed portion of the metallic wires for securing the metallic wires to the mounting member.

In certain embodiments, the method may comprise deforming the end fitting to seal the end fitting against the pipe body prior to the applying the retaining material and thereby forming an annular chamber between the pipe body and the mounting member for receiving the retaining material to secure the metallic wires to the mounting member.

In certain embodiments, the applying the retaining material may be prior to the providing the end fitting to form the first end of the pipe body as an enlarged end and the method may comprise deforming the end fitting over the enlarged end to seal the end fitting against the pipe body and thereby secure the metallic wires to the mounting member.

In certain embodiments, the method may comprise introducing the first end of the pipe body into a removable mould for receiving the retaining material prior to applying the retaining material.

In certain embodiments, the deforming the end fitting may be by swaging or crimping. In certain embodiments, the pipe body may further have a second pipe layer disposed about the first pipe layer and the method may comprise removing the second pipe layer over the length of the pipe body at the first end thereof prior to the removing at least a portion of the matrix material.

In certain embodiments, the retaining material may be an epoxy resin or other adhesive polymer material, and optionally the retaining material may comprise a filler material for increasing stiffness.

### BRIEF DESCRIPTION OF THE DRAWINGS

FIG. 1 is a partial cross-sectional view of a flexible pipe according to an embodiment of the invention;

FIG. 2 is a partial cross-sectional view of a flexible pipe according to a further embodiment of the invention;

FIG. 3 is a flowchart of a method for connecting an end fitting to a pipe body of a flexible pipe according to an embodiment of the invention; and

FIGS. 4-A to 4-C are a series of partial cross-sectional views of a pipe body, showing steps of a method according to a further embodiment of the invention.

### DETAILED DESCRIPTION OF EMBODIMENTS OF THE INVENTION

Embodiments of the invention may have particular application for use as an onshore pipe for conveying oil and gas field fluids, such fluids including one or more of gas (e.g., methane, ethane, hydrogen, or CO₂), hydrocarbon fluids (e.g., oil), water, or other fluids (e.g., slurry). Moreover, embodiments of the invention may have particular application as RTP, which may be manufactured as described in API standard 15S. However, other applications are contemplated.

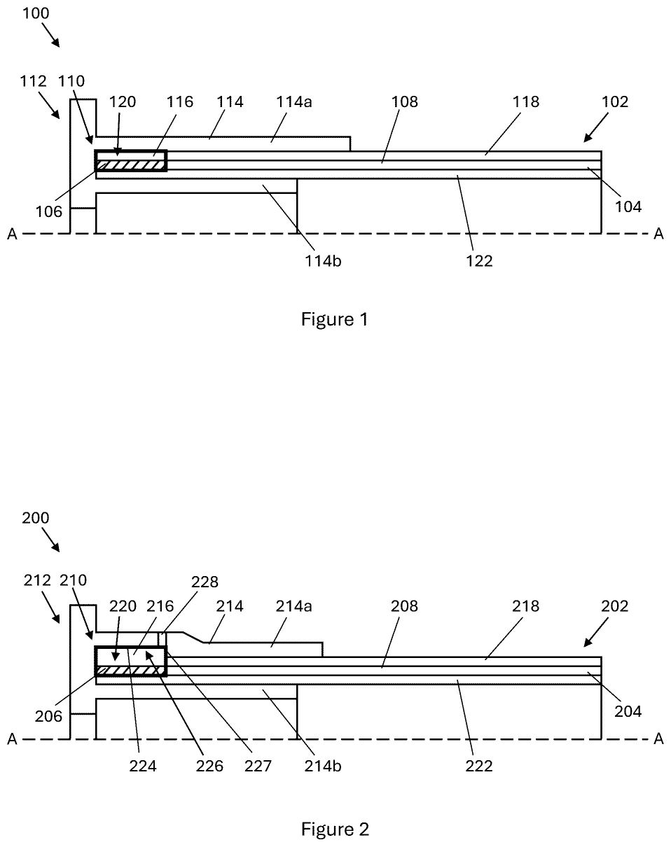

FIG. 1 shows a flexible pipe 100 according to an embodiment of the invention. The pipe 100 extends along a central longitudinal axis A-A and comprises a pipe body 102 having a first pipe layer 104. The first pipe layer 104 comprises a plurality of metallic wires 106 encapsulated in a matrix material 108. The metallic wires 106 serve as reinforcement, providing the pipe 100 with the mechanical strength required to withstand internal pressures, and other forces, experienced by the pipe 100 in service. The matrix material 108 provides protection to the metallic wires 106, i.e., the encapsulation of the metallic wires 106 in the matrix material 108 shields them from environmental factors, chemical exposure, and/or physical damage. Crucially, the first pipe layer 104 is at least partially free of the matrix material 108 over a length of the pipe body 102 at a first end 110 thereof. A portion of the metallic wires 106 are therefore exposed from the matrix material 108. The first pipe layer 104 may be formed of at least one tape, and/or the matrix material 108 may be a thermoplastic matrix material.

The pipe 100 further comprises an end fitting 112, in which the first end 110 of the pipe body 102 is mounted, the end fitting 112 comprising a mounting member 114 that is concentric to the first pipe layer 104, and a retaining material 116 applied to the exposed portion of the metallic wires 106. The retaining material 116 may be connected or bonded to the exposed portion of the metallic wires 106. The retaining material 116 secures the metallic wires 106 to the mounting member 114, as is described in further detail below.

In some embodiments, the retaining material 116 may be an adhesive, e.g., the retaining material 116 may be an epoxy resin or other adhesive polymer material. The retaining material 116 may therefore be adhesively bonded to the exposed portion of the metallic wires 106. The retaining material 116 may substantially encapsulate the metallic wires 106. The metallic wires 106 may be ribbed, bent, or crimped, so as to improve the adhesive bond between the metallic wires 106 and the retaining material 116.

The retaining material 116 may be applied to the metallic wires 106 before the pipe body 102 is mounted in the end fitting 112. For example, the retaining material 116 may be applied to, and retained around, the metallic wires 106 using a removable mould (not shown) disposed about the pipe body 102. The removeable mould may configured such that the retaining material 116 does not adhesively bond to the metallic wires 106 whilst the removable mould is disposed about the pipe body 102, e.g., the retaining material 116 may be air setting and the removable mould may provide a vacuum such that the retaining material 116 does not set. The removable mould may be removed prior to mounting the pipe body 102 in the end fitting 112.

Alternatively, or additionally, the retaining material 116 may be applied to the metallic wires 106 after the pipe body 102 is mounted in the end fitting 112. The end fitting 112 may comprise a port (not shown), as described in relation to FIG. 2, for introducing the retaining material 116 between the first pipe layer 104 and the mounting member 114. The port may be disposed along a length of the mounting member 114 that is that is concentric to the first end 110 of the pipe body 102 such that the retaining material 116 may be applied to the exposed portion of the metallic wires 106. The port may extend between a radially outer surface of the mounting member 114 and a radially inner surface of the mounting member 114. The end fitting 112 may comprise multiple ports (not shown) spaced from one another about the circumference of the mounting member 114 so as to provide a uniform distribution of the retaining material 116 between the first pipe layer 104 and the mounting member 114. The port may include a valve (not shown) configured to control and/or inhibit the flow of the retaining material 116 through the port.

On mounting the pipe body 102 in the end fitting 112, the mounting member 114 is proximate to the metallic wires 106. In this way, the retaining material 116, applied to the metallic wires 106, may also adhesively bond to the mounting member 114 to secure the metallic wires 106 to the mounting member 114. In certain embodiments, the mounting member 114 may comprise serrations or undulations (not shown) to improve the bond and/or load transfer between the mounting member 114 and the retaining material 106.

In certain embodiments, the retaining material 116 may comprise a filler material (not shown) for increasing stiffness of the flexible pipe 100. The retaining material 116 may be connected to the metallic wires 106, e.g., the retaining material 116 may be meshed or interlaced with the metallic wires 106. On mounting the pipe body 102 in the end fitting 112, the retaining material 116 may provide an interference fit, i.e., a frictional connection with the mounting member 114 to secure the metallic wires 106 to the mounting member 114. The retaining material 106 may comprise further metallic wires, aramid fibres, carbon fibres, or any other suitable filler material. Alternatively or additionally, the metallic wires 106 may be manipulated to provide the retaining material 116. For example, the metallic wires 106 may be bent to provide a return and/or splayed outwardly.

Providing the retaining material 116 to secure the metallic wires 106 to the mounting member 114 improves the load transfer between the metallic wires 106 and the mounting member 114 and/or the retaining material 116 inhibits movement between the first pipe layer 104 and the mounting member 114 so as to prevent pull out of the pipe body 102 from the end fitting 112, during use.

The length of the first end 110 of the pipe body 102 (i.e., the length along which the metallic wires 106 are exposed) may be approximately 1 inch (25.4 mm). In other embodiments, the length of the first end 110 of the pipe body 102 may be less than, or greater than, 1 inch (25.4 mm). Increasing the length of the first end 110 of the pipe body 102 allows for a larger amount of the retaining material 116 to be applied to the metallic wires 106, thereby improving the load transfer between the metallic wires 106 and the mounting member 114 and/or further inhibiting movement between the first pipe layer 104 and the mounting member 114.

As shown in FIG. 1, the pipe body 102 has a second pipe layer 118 disposed about the first pipe layer 104. However, in other embodiments, the pipe body 102 may not have the second pipe layer 118. The second pipe layer 118 is disposed about a radially outer surface of the first pipe layer 104 such that there is substantially no gap therebetween. The first pipe layer 104 and the second pipe layer 118 thereby extend coaxially with one another. The second pipe layer 118 may be a polymer layer and/or may provide a fluid barrier layer of the pipe body 102.

The second pipe layer 118 does not extend over the length of the first end 110 of the pipe body 102 such that the metallic wires 106 of the first pipe layer 104 are exposed. An annular chamber 120 for receiving the retaining material 116 is thereby be defined between the metallic wires 106 and the mounting member 114. The retaining material 116 applied to the plurality of metallic wires 106 substantially fills the annular chamber 120 such that the metallic wires 106 may be secured to the mounting member 114. The retaining material 116 thereby provides a single solid ring between the first pipe layer 104 and the mounting member 114.

As further shown in FIG. 1, the pipe body 102 has a third pipe layer 122 about which the first pipe layer 104 is disposed. However, in other embodiments, the pipe body 102 may not have the first pipe layer 104. The third pipe layer 122 is disposed within a radially inner surface of the first pipe layer 104 such that there is substantially no gap therebetween. The first pipe layer 104 and the third pipe layer 122 thereby extend coaxially with one another. The third pipe layer 122 may be a polymer layer and/or may provide a liner of the pipe body 102.

In some embodiments, the third pipe layer 122 may not extend over the length of the pipe body 102 at the first end 110 such that the metallic wires 106 are exposed. A further annular chamber (not shown) for receiving the retaining material 116 may thereby be defined between the metallic wires 106 and the mounting member 114. The retaining material 116 may substantially fill the further annular chamber such that the metallic wires 106 may be secured to the mounting member 114. Optionally, the retaining material 116 may substantially fill both the annular chamber 120 and the further annular chamber.

The mounting member 114 of the end fitting 112 may be deformed to seal at least a portion of the end fitting 112 against the pipe body 102. In certain embodiments, the mounting member 114 may not be deformed over the first end 110 of the pipe body 102, i.e., that comprising the retaining material 116. In this way, the retaining material 116 may provide that the first end 110 of the pipe body 102 is an enlarged end, i.e., due to the retaining material 116, the first end 110 of the pipe body 102 has a greater external diameter than the remaining portions of the pipe body 102. Due to the deforming of the mounting member 114, the annular chamber 120 and/or the further annular chamber (not shown) may provide an undercut portion to abut the enlarged end of the pipe body 102, in use. Movement between the first pipe layer 104 and the mounting member 114 may thereby be further inhibited, so as to prevent pull out of the pipe body 102 from the end fitting 112, during use.

The mounting member 114 comprises a ferrule 114a, i.e., an outer mounting member, disposed about the second pipe layer 118. The mounting member 114 may also comprise a stem 114b, i.e., an inner mounting member, disposed within the third pipe layer 122. However, it would be understood that the mounting member 114 may comprise the ferrule 114a and/or the stem 114b. The ferrule 114a and/or the stem 114b may be deformed to seal the end fitting 112 against the pipe body 102. For example, the ferrule 114a and/or the stem 114b may be swaged and/or crimped.

The ferrule 114a is disposed coaxially about the stem 114b to delimit an annular recess (not shown) extending radially between the ferrule 114a and the stem 114b for receiving the pipe body 102. The ferrule 114a and the stem 114b may be configured to be deformed towards one another such that the annular thickness, i.e., the radial distance between the ferrule 114a and the stem 114b, of the annular recess is substantially reduced and the end fitting 112 is sealed against the pipe body 102.

Turning to FIG. 2, there is illustrated a flexible pipe 200 according to a further embodiment of the invention. The same reference numerals, offset by a factor of 100, are used to identify the same or similar features as described above.

As shown in FIG. 2, the flexible pipe 200 may comprise a modified end fitting 212. The end fitting 212 comprises an annular channel 226 that is concentric to the length of the pipe body 202 at the first end 210 thereof. The annular channel 226 is delimited by an enlarged diameter of a length of the radially inner surface 224 of the ferrule 214a that is concentric to the length of the first end 210 of the pipe body 202. The enlarged diameter has a greater internal diameter than remaining portions of the radially inner surface 224 of the ferrule 214a. The radially inner surface 224 of the ferrule 214a is stepped in a direction perpendicular to the longitudinal axis A-A to provide the enlarged diameter. In other embodiments, the radially inner surface 224 of the ferrule 214a may be radially tapered with respect to the longitudinal axis A-A to provide the enlarged diameter.

The annular channel 226 forms part of the annular chamber 220. The annular channel 226 thereby receives at least a portion of the retaining material 216 therein to secure the metallic wires 206 to the ferrule 214a. The retaining material 216 thereby provides that the first end 210 of the pipe body 202 is an enlarged end, i.e., due to the retaining material 216, the first end 210 of the pipe body 202 has a greater external diameter than the remaining portions of the pipe body 202. The annular channel 226 may provide an undercut portion 227 to abut the enlarged end of the pipe body 202, in use. The annular channel 226 thereby further inhibits movement of the first pipe layer 204 in relation to the ferrule 214a, and allows for a reduction in the length of the first end 210 of the pipe body 202.

As further shown in FIG. 2, the end fitting 212 comprises a port 228 for introducing the retaining material 216 between the first pipe layer 204 and the mounting member 214, as described in relation to FIG. 1. At least one such port 228 may be required for introducing the retaining material 216. In certain embodiments, at least one further port (not shown) may be included as an exit port for the retaining material which may help ensure, when introducing the retaining material, that it adequately fills the annular chamber 220. This may be configured so that the entry port 228 is at a low gravitational position in the fitting, and the exit port at a high gravitational position ensuring that when the retaining material 216 starts to exit the higher port, the annular chamber 220 is completely filled with retaining material.

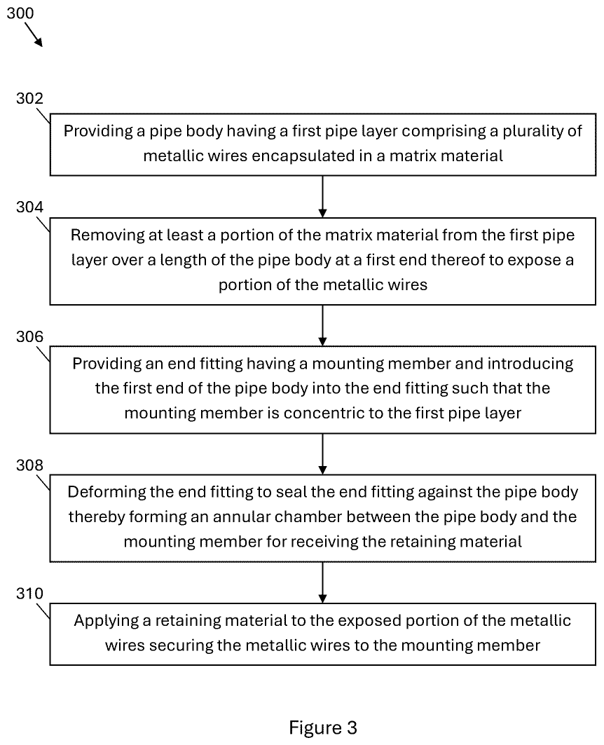

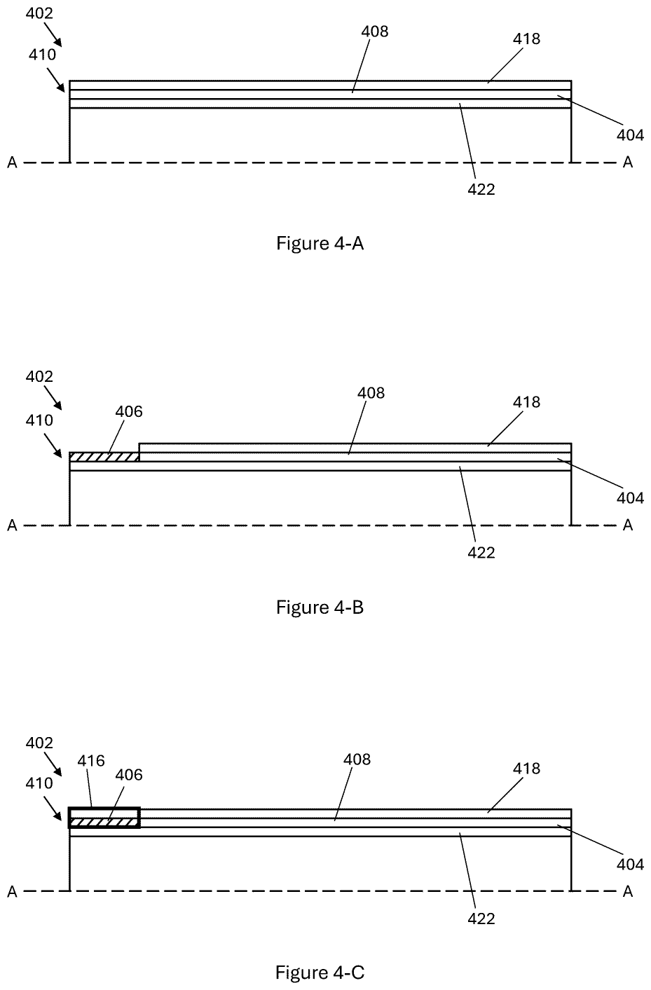

FIG. 3 shows a flowchart of a method 300 for connecting the end fitting to the pipe body according to an embodiment of the invention. The method is described with reference to FIGS. 4-A to 4-C, which show a series of partial cross-sectional views of the pipe body 402 according to an embodiment of the invention. The same reference numerals, offset by a factor of 100, are used in FIGS. 4-A to 4-C to identify the same or similar features as described above.

The method 300 comprises a first step 302 of providing the pipe body 402 having the first pipe layer 404 comprising the plurality of metallic wires 406 encapsulated in the matrix material 408. The first pipe layer 404 may be formed of a tape, and/or the matrix material 408 may be a thermoplastic matrix material. FIG. 4-A shows the pipe body 402, having the first pipe layer 404 disposed between the second and third pipe layers 418, 422, as described in relation to FIG. 1. The matrix material 408 of the first pipe layer 404 however extends to and/or over the first end 410 of the pipe body 402 such that the plurality of metallic wires 406 are not exposed. The second and third pipe layers 418, 422 also extends to and/or over the first end 410 of the pipe body 402.

The method 300 comprises a second step 304 of removing at least the portion of the matrix material 408 from the first pipe layer 404 at the first end 410 of the pipe body 402 to expose the portion of the metallic wires 406. As shown in FIG. 4-B, prior to removing the matrix material 408 of the first pipe layer 404, the second pipe layer 418 is removed at the first end 410 of the pipe body 402 so as to enable the removal of the matrix material 408. In other embodiments, the third pipe layer 422 may additionally, or alternatively, be removed at the first end 410 of the pipe body 402. The second pipe layer 418 and/or third pipe layer 422 may be removed by machining a desired length of the layer off, or cutting around the circumference at a desired distance with such as a hot knife, separating the section and removing it from the first end 410. The second pipe layer 418 and/or the third pipe layer 422 of the pipe body 402 may be trimmed back from the first end 410 by any other methods known in the art.

On removal of the second layer 418 and/or the third layer 422 from the first end 410 of the pipe body 402, the portion of the matrix material 408 is removed from the first pipe layer 404. In certain embodiments, the matrix material 408 may be heated at the first end 410 of the pipe body 402 to at least partially melt the matrix material 408. The at least partially melted matrix material 408 may, in turn, be manipulated and/or removed to expose the portion of the plurality of metallic wires 406. The matrix material 408 may be substantially completely removed from the first pipe layer 404. Alternatively, the matrix material 408 may be partially removed from the first pipe layer 404, e.g., a radially outer and/or inner portion of the matrix material 408 may be removed. The matrix material 408 may be heated by infrared radiant heating, hot gas convection heating, laser heating, or any other methods known in the art. Alternatively, the matrix material 408 may be removed using chemical means, such as where the matrix material is softened or at least partially dissolved by application of a solvent to the portion of the matrix material 408 to be removed, which may be followed by mechanical removal of remaining matrix material.

The method 300 comprises a third step 306 of providing the end fitting (not shown) having the mounting member (not shown) and introducing the first end 410 of the pipe body 402 into the end fitting such that the mounting member is concentric to the first pipe layer 404. The end fitting may be configured as described in relation to FIG. 1 or 2. The pipe body 402 may be introduced into the end fitting until the first end 410 of the pipe body 402 abuts an end (not shown) of the end fitting.

The method 300 comprises a fourth step 310 of applying the retaining material 416 to the exposed portion of the metallic wires 406 for securing the metallic wires 406 to the mounting member. Crucially, the retaining material 416 inhibits movement between the first pipe layer 404 and the mounting member so as to prevent pull out of the pipe body 402 from the end fitting, during use.

In some embodiments, the retaining material 416 may be an adhesive, e.g., the retaining material 416 may be an epoxy resin or other adhesive polymer material. As described in relation to FIG. 1, the retaining material 416 may be introduced between the first pipe layer 404 and the mounting member through the port (not shown) of the end fitting. Once disposed between the metallic wires 406 and the mounting member, the retaining material 416 may adhesively bond to the metallic wires 406 and the mounting member so as to secure the metallic wires 406 to the mounting member.

In some embodiments, the method 300 may comprise an intermediate step 308 of deforming the end fitting to seal the end fitting against the pipe body 402, prior to the step 310 of applying the retaining material 416. Deforming the end fitting may form an annular chamber (not shown) between the pipe body 402 and the mounting member for receiving the retaining material 416 to secure the metallic wires 406 to the mounting member. Importantly, to form the annular chamber, the end fitting is not deformed over the first end 410 of the pipe body 402. Disposing retaining material 416 in the annular chamber may provide that the first end 410 of the pipe body 402 is an enlarged end, i.e., due to the retaining material 416, the first end 410 of the pipe body 402 has a greater external diameter than the remaining portions of the pipe body 402. The annular chamber may provide an undercut portion (not shown) to abut the enlarged end of the pipe body 402, in use. Movement between the first pipe layer 402 and the mounting member may thereby be further inhibited, so as to prevent pull out of the pipe body 402 from the end fitting, during use.

In other embodiments, as shown in FIG. 4-C, the method 300 may comprise the step 310 of applying the retaining material 416, prior to the step 306 of providing the end fitting, so as to form the first end 410 of the pipe body 402 as an enlarged end (not shown). In such an embodiment, the method 300 may comprise introducing the first end 410 of the pipe body 402 into a removable mould (not shown) for receiving the retaining material 416, prior to step 310 of applying the retaining material 416. In this way, the retaining material 416, for example an adhesive, may be confined around the metallic wires 406. The method 300 may further comprise removing the removable mould prior to mounting the pipe body 402 in the end fitting.

Additionally, or alternatively, the method 300 may comprise sliding the ferrule 114a of the end fitting onto the body pipe past the prior to applying the retaining material 416, and subsequently connecting the ferrule 114a to the rest of the end fitting 112 via means of fasteners or a screw thread or other known means. In this way, the outer diameter of the retaining material 416 may be much larger than the outer diameter of the pipe body 202, and so help reduce the degree of swaging required to crimp and seal the ferrule 114a around the second layer 118. This may also facilitate load transfer from the pipe body 402 into the end fitting 112. In certain embodiments, a conical (tapered) internal surface of the ferrule 114a, opening out towards the pipe end 410, may also be included to provide an additional securing radial force, through the wedge effect, to the metallic wires 406 when axial load is applied to the pipe.

Where the retaining material 416 comprise a filler material, the filler material may be confined about the metallic wires 406 without the removable mould, i.e., the filler material may be meshed or interwoven with the metallic wires 406. The method 300 may further comprise deforming the end fitting over the enlarged end to seal the end fitting against the pipe body 402 and thereby secure the metallic wires 406 to the mounting member.

The end fitting may be deformed by swaging or crimping. The swaging or crimping may comprise clamping the mounting member to the pipe body 402 such that the end fitting is sealed against the pipe body 402, i.e., applying a radially inward and/or outward pressure to the mounting member against the pipe body 402. The swaging or crimping may be performed by any methods known in the art.

The invention is not restricted to the details of any foregoing embodiments. Throughout the description and claims of this specification, the words “comprise”, “contain”, “having” and variations of them mean “including but not limited to”, and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, and characteristics, described in conjunction with a particular aspect, embodiment or example of the invention are to be understood to be applicable to any other aspect, embodiment or example described herein unless incompatible therewith. In particular, the phrase “certain embodiments” is to be understood to mean any embodiment described, illustrated, or otherwise disclosed herein. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

1. A flexible pipe comprising:
a pipe body having a first pipe layer formed of a tape comprising a plurality of metallic wires encapsulated in a thermoplastic matrix material, the first pipe layer at least partially free of the matrix material over a length of the pipe body at a first end thereof so exposing a portion of the metallic wires;
an end fitting in which the first end of the pipe body is mounted, the end fitting comprising a mounting member concentric to the first pipe layer; and
a retaining material applied to the exposed portion of the metallic wires securing the metallic wires to the mounting member.

2. A flexible pipe according to claim 1, wherein the retaining material is an adhesive or is adhesively bonded to the mounting member.

3. A flexible pipe according to claim 1, wherein the retaining material is an epoxy resin or other adhesive polymer material, and optionally wherein the retaining material comprises a filler material for increasing stiffness.

4. A flexible pipe according to claim 1, wherein the end fitting comprises a port for introducing the retaining material between the first pipe layer and the mounting member, and optionally wherein the port includes a valve.

5. A flexible pipe according to claim 1, wherein the retaining material provides that the first end of the pipe body is an enlarged end.

6. A flexible pipe according to any claim 1, wherein the pipe body further has a second pipe layer disposed about the first pipe layer, the second pipe layer not extending over the length of the pipe body at the first end.

7. A flexible pipe according to claim 6, wherein the mounting member comprises a ferrule disposed about the second pipe layer.

8. A flexible pipe according to claim 6, wherein the second pipe layer is a polymer layer and/or provides a fluid barrier layer of the pipe body.

9. A flexible pipe according to claim 1, wherein the pipe body further has a third pipe layer about which the first pipe layer is disposed, the third pipe layer not extending over the length of the pipe body at the first end.

10. A flexible pipe according to claim 9, wherein the mounting member comprises a stem disposed within the third pipe layer.

11. A flexible pipe according to claim 9, wherein the third pipe layer is a polymer layer and/or provides a liner of the pipe body.

12. A flexible pipe according to claim 1, wherein the end fitting comprises an annular channel that is concentric to the length of the pipe body at the first end thereof.

13. The use of a flexible pipe according to claim 1 as an onshore pipe for conveying oil and gas field fluids, and wherein optionally the flexible pipe is a reinforced thermoplastic pipe.

14. A method for connecting an end fitting to a pipe body of a flexible pipe, the method comprising:
providing a pipe body having a first pipe layer formed of a tape comprising a plurality of metallic wires encapsulated in a thermoplastic matrix material;
removing at least a portion of the matrix material from the first pipe layer over a length of the pipe body at a first end thereof to expose a portion of the metallic wires;
providing an end fitting having a mounting member and introducing the first end of the pipe body into the end fitting such that the mounting member is concentric to the first pipe layer; and
applying a retaining material to the exposed portion of the metallic wires for securing the metallic wires to the mounting member.

15. A method according to claim 14, wherein the method comprises deforming the end fitting to seal the end fitting against the pipe body prior to the applying the retaining material and thereby forming an annular chamber between the pipe body and the mounting member for receiving the retaining material to secure the metallic wires to the mounting member.

16. A method according to claim 14, wherein the applying the retaining material is prior to the providing the end fitting to form the first end of the pipe body as an enlarged end and the method comprises deforming the end fitting over the enlarged end to seal the end fitting against the pipe body and thereby secure the metallic wires to the mounting member.

17. A method according to claim 16, wherein the method comprises introducing the first end of the pipe body into a removable mould for receiving the retaining material prior to applying the retaining material.

18. A method according to claim 15, wherein the deforming the end fitting is by swaging or crimping.

19. A method according to claim 14, wherein the pipe body further has a second pipe layer disposed about the first pipe layer and the method comprises removing the second pipe layer over the length of the pipe body at the first end thereof prior to the removing at least a portion of the matrix material.

20. A method according to claim 14, wherein the retaining material is an epoxy resin or other adhesive polymer material, and optionally wherein the retaining material comprises a filler material for increasing stiffness.
